(19) United States
(12) Patent Application Publication
(10) Pub. No.: US 2014/0015226 A1
(43) Pub. Date: Jan. 16, 2014

(54) Trailer Ball Hitch with Recessed Lock Lever with Lever Latch

(71) Applicant: Tie Down, Inc., Atlanta, GA (US)

(72) Inventor: Charles J. MacKarvich, Atlanta, GA (US)

(21) Appl. No.: 14/012,519

(22) Filed: Aug. 28, 2013

Related U.S. Application Data
(63) Continuation-in-part of application No. 13/675,486, filed on Nov. 13, 2012.
Application No. 13/675,486 is a continuation-in-part of application No. 13/172,014, filed on Jun. 29, 2011, now Pat. No. 8,342,559.

(51) Int. Cl. B60D 1/06

(52) U.S. Cl. CPC B60D 1/065
USPC 280/509

(57) ABSTRACT

A ball clamp 30 has a semi-spherical surface that is urged by coil compression spring 34 into engagement with the spherical surface of a hitch ball. An L-shaped flange 73 on the rear of the ball clamp guides the groove 75 along the length of the sloped guide tongue 69 of the ball clamp support 65, assuring that the ball clamp 30 is properly supported and accurately positioned during its movements toward and away from the ball hitch 12. The ball socket housing 22 includes a recess 137 on its top surface and the locking lever 136 pivots into said recess upon contact by an approaching obstacle for avoiding destructive contact with the obstacle. The latch lever 136 has an intermediate portion 135 connected to the clamp pin 132, a fulcrum 140 at one end and a lifting end 146, and a latch catch surrounding said clamp pin for engaging the fulcrum end to hold the latch lever upright.

### CROSS REFERENCE

This is a continuation-in-part of U.S. patent application Ser. No. 13/675,486 filed in the U.S. Patent & Trademark Office on Nov. 13, 2012, and a continuation-in-part of U.S. patent application Ser. No. 13/172,014 filed in the U.S. Patent and Trademark Office on Jun. 29, 2011.

### FIELD OF THE INVENTION

This invention concerns a trailer hitch that is used to connect a towed trailer to the hitch ball of a towing vehicle. More particularly, the invention concerns a lock mechanism for automatically locking the trailer hitch to the hitch ball of the towing vehicle, and a lock lever configuration for a trailer hitch for opening and closing the lock and that faces in the direction that closes in response to an accidental frontal impact by the towing vehicle.

Hitch balls and ball sockets with automatic locks are known in the art, as disclosed in U.S. Pat. Nos. 7,690,673 and 8,342,559.

### BACKGROUND OF THE INVENTION

Trailer hitches for small vehicles usually include a socket that connects to a hitch ball mounted on the rear end of a towing vehicle. The trailer usually includes a forwardly extending trailer draft tongue that includes a coupler having the downwardly facing ball socket that is to be placed over and pivotally connects to the upwardly extending hitch ball.

When the towing vehicle is to be connected to the trailer, the operator typically elevates the trailer tongue so that the socket of the coupler is at a slightly higher level than the level of the hitch ball that is carried by the towing vehicle. The operator backs the towing vehicle toward the anticipated position of the socket of the coupler until the operator estimates that the hitch ball is aligned below the socket of the coupler. The operator then stops the vehicle, exits the vehicle and lowers the trailer tongue until the socket of the hitch registers with the hitch ball and the trailer is mounted to the hitch ball.

It is important that the ball socket of the coupler is properly mounted on and is locked to the hitch ball, and most trailer hitches include a lever actuated clamp that is movable to extend a locking element from the trailer hitch to a position toward the neck of the hitch ball, below the larger lateral breadth of the hitch ball, for locking the trailer hitch to the hitch ball of the towing vehicle. Without this type of lock, there is a hazard that the trailer hitch will tend to bounce off the hitch ball upon the vehicle and/or the trailer passing over bumps in the road, or upon braking or accelerating, or upon side forces received from winds, or turns of the towing vehicle, etc., or upon the trailer being out of balance. Accordingly, the driver of a towing vehicle, when in the driver's position within the vehicle, is not likely to remain in the vehicle and to allow someone else to lock the trailer hitch to the hitch ball of the towing vehicle. This means that the driver is likely to apply the emergency brakes to the towing vehicle, exit the truck, and then make sure that the lock is secure between the trailer and the towing vehicle. While this operation is likely to increase the safety of the connection between the towing vehicle and the trailer, it leaves the towing vehicle and the trailer unattended for accidental movement during the locking procedure. Also, it is possible that the conventional clamp device used to connect the trailer hitch to the hitch ball might be inadvertently left open or could be accidently engaged by another obstacle that causes the clamp to open.

Since the procedure for connecting the trailer coupler to the hitch ball may be performed by only one person, the driver of the vehicle, there is a hazard that the trailer hitch lever will be accidentally engaged and damaged by the oncoming towing vehicle and/or its hitch ball. Also, it is desirable that the trailer hitch remain open during the procedure of aligning the hitch with the hitch ball, and then having the hitch connect to the hitch ball in response to the hitch moving down about the hitch ball.

It is to the above described issues that the following disclosure is directed.

### SUMMARY OF THE DISCLOSURE

Briefly described, the present disclosure concerns a trailer hitch for mounting the draw bar of a trailer to a conventional hitch ball of a towing vehicle. The hitch ball typically includes a dome shaped upper portion and a lower portion that converges beneath the larger lateral breadth of the dome shaped upper portion to a stem of a smaller breadth. The trailer hitch may include a socket housing that has a downwardly facing ball socket for mounting on the upwardly facing hitch ball. The ball socket defines a downwardly facing semi-spherical upper interior surface that corresponds in size and shape to the semi-spherical hitch ball.

A ball clamp is supported by the socket housing for engaging the hitch ball at the stem of the hitch ball below the larger intermediate lateral breadth of the hitch ball for locking the trailer hitch to the hitch ball of the towing vehicle.

The trailer hitch herein disclosed includes a ball clamp with a concave surface of a size and shape that is coextensive with the shape of the semi-spherical interior surface of the ball socket when engaging the hitch ball at the stem of the hitch ball below the larger lateral breadth of the hitch ball.

The concave surface of the ball clamp may include an arcuate surface, and a biasing means may be supported by the socket housing for urging the ball clamp toward the hitch ball at the stem of the hitch ball for locking the ball clamp to the hitch ball.

The biasing means may include a coil compression spring that engages the ball clamp, and a clamp pin may be connected to the ball clamp with the coil compression spring surrounding the clamp pin for urging the ball clamp toward its locked position.

The trailer hitch may include a ball clamp movably supported by a ball socket assembly, a ball clamp support mounted to the ball socket assembly configured to guide the ball clamp toward and away from its locking position and for supporting the ball clamp when the ball socket is mounted on the hitch ball with the ball clamp in its locking position.

The ball clamp and the ball clamp support may include a tongue and groove connection that guides the ball clamp along the clamp support. In one embodiment a sloped guide tongue extends parallel to the path of movement of the ball clamp, and the ball clamp includes an L-shaped flange that forms a tongue groove that is sized and shaped to receive the sloped guide tongue and guide the ball clamp along the sloped guide tongue toward and away from its locking position.

A lock lever is mounted on the upper exterior surface of the ball socket assembly. The lock lever may include an intermediate portion connected to the clamp pin, a handle extending from the intermediate portion in one direction away from the clamp pin, and a fulcrum extending in another direction from the clamp pin opposite to the handle.

In one embodiment the socket housing includes in its upper surface a lever recess that is sized and shaped to receive the lock lever when the lock lever is oriented horizontally, so that the lock lever is substantially flush with the upper surface of the socket housing so that the lock lever is protected from inadvertent engagement by accidental movement of the hitch ball or other object, such as when the ball socket assembly is being connected to the hitch ball. Also, the handle of the lock lever may be directed rearwardly of the ball socket housing so that if the handle is up when engaged by the towing vehicle, the handle will be pushed rearwardly to pivot down into the lever recess to avoid damage to the lever.

A latch catch may be positioned at the lock lever to become engaged by the fulcrum of the lock lever to hold the lock lever in its up position, thereby holding the ball clamp up and maintaining the ball socket assembly in its open position. This retards the release of the fulcrum, to hold the ball socket in its open position after the trailer hitch has been disengaged from the ball hitch.

The latch catch may be shaped so that when the lock lever is up and the open ball socket is moved down on the hitch ball, the upward movement of the ball clamp caused by engaging the hitch ball causes the lock lever to lift away from the latch catch. This allows the spring of the ball socket assembly to tilt the lock lever back to its horizontal position as the lock lever engages the surface of the ball socket and come to nest in the recess of the ball socket housing.

The ball socket assembly may include a shield mounted to the ball socket beneath the ball clamp and shaped to cover the bottom surface of the ball clamp and define a semi-circular recess for admitting a hitch ball to move into engagement with said ball clamp.

The above described features of this disclosure, as well as the others hereinafter described, provide a trailer hitch that, when applied to the hitch ball, is self-locking. The trailer hitch has a ball clamp that is urged at an upward angle out of the way when the hitch socket is lowered onto the hitch ball to allow the socket to become properly placed on the hitch ball, and once properly positioned on the hitch ball, the ball clamp is biased into locking engagement with the hitch ball.

This provides the vehicle operator with the knowledge that once the trailer hitch is mounted to the hitch ball, it is locked in place and does not require his personal attention to properly secure the trailer hitch to the hitch ball. This reduces the hazard of improper locking of the trailer hitch to a hitch ball.

### BRIEF DESCRIPTION OF THE DRAWINGS

FIG. 1 is a top view of a trailer hitch assembly.

FIG. 2 is a side cross sectional view of the trailer hitch along lines 2-2 of FIG. 1.

FIG. 3 is a perspective phantom view of the trailer hitch of FIGS. 1 and 2, with the lever in its locked position.

FIG. 4 is a perspective phantom view of the trailer hitch of FIG. 3, but showing the lever in its open position

FIG. 5 is a side view of the ball clamp, lever, clamp pin, coil spring and the shape of a portion of the ball socket, with the ball clamp and top wall of the ball socket shown in cross section.

FIG. 6 is a top view of the ball clamp.

FIG. 7 is a back view of the ball clamp, clamp pin, spring and lever, taken along lines 7-7 of FIG. 5.

FIG. 8 is a front view of the ball clamp, clamp pin, spring and lever, taken along lines 8-8 of FIG. 5.

FIG. 9 is a cross sectional view of the ball hitch, showing the movement of the ball clamp as the ball hitch is moved down onto a hitch ball.

FIG. 10 is a cross sectional view of the ball hitch, showing how the ball clamp is moved upwardly in response to opening the lever.

FIG. 11 is a perspective view of the ball clamp and the ball clamp support in an expanded relationship, showing the movement of the ball clamp along the tongue of the ball clamp support.

FIG. 12 is a perspective view of a second embodiment of the invention, showing the lock lever nested in its lock lever recess on the top wall of the socket housing of the trailer hitch assembly.

FIG. 13 is a side cross sectional view of the second embodiment, showing how the lock lever avoids damage if it is engaged by another object such as the moving tow truck.

FIG. 14A is a side cross sectional view of the second embodiment, similar to FIG. 13 but showing the lock lever in its raised position when the ball clamp is in its open position and the fulcrum of the lock lever engaged by the latch catch.

FIG. 14B is a close-up cross sectional view of the second embodiment, showing the lock lever in its raised position.

FIG. 15 is a perspective view of the second embodiment of the invention, showing the lock lever in its raised position, when it is tilted up and extending out of the lock lever recess of the mounting sleeve of the trailer hitch.

FIGS. 16A and 16B are perspective views of the latch catch.

FIGS. 17A-17D are perspective, top, side and bottom views, respectively, of the latch catch.

### DETAILED DESCRIPTION

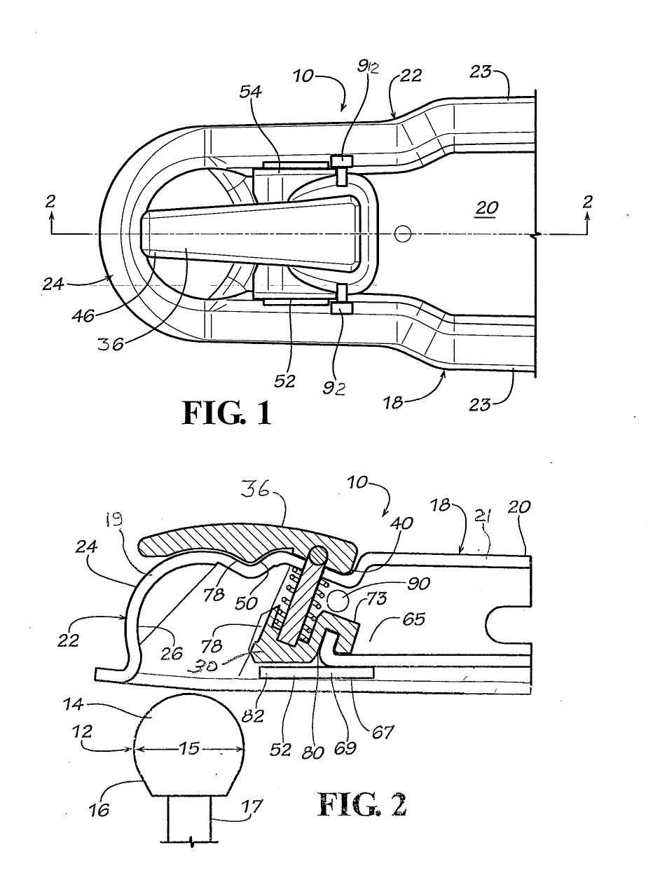

Referring now in more detail to the drawings, in which like numerals indicate like parts throughout the several views, FIGS. 1 and 2 illustrate a trailer hitch 10 that is to be mounted to a hitch ball 12 that is projected from the rear of a towing vehicle (not shown) in a conventional manner. The hitch ball 12 is semi-spherical, including a semi-spherical upper portion 14 having a lateral breadth 15, and a converging lower portion 16, with a support stem 17 that extends downwardly to the device that connects the hitch ball to the towing vehicle (not shown). This is conventional.

Trailer hitch 10 includes a socket housing 19 that includes a mounting sleeve 18 that is mounted to the forward end of a draw bar (not shown) that extends back to the trailer that is to be towed. The mounting sleeve 18 typically will be formed in an inverted U-shape, with a horizontal top wall 20 and opposed vertically oriented side walls 23. Mounting sleeve 18 of the socket housing 19 supports at its forward end the trailer hitch 10, and may also support the brake cylinders, electrical wiring and other components not further described herein.

As shown in FIG. 2, the trailer hitch 10 is to be mounted on the conventional hitch ball 12, by resting on the semi-spherical shape that includes the dome-shaped upper portion 14 that expands downwardly to the large lateral intermediate breadth 15, then converges to the lower portion.

The trailer hitch 10 includes a ball socket assembly 22 for mounting on the hitch ball, with the ball socket assembly including a ball socket 24 that is to be mounted to the hitch ball.

The ball socket includes a concave interior upper surface 26 that corresponds in size and shape to the semi-spherical upper portion 14 of the hitch ball 12 for mounting about the semi-spherical upper portion of the hitch ball.

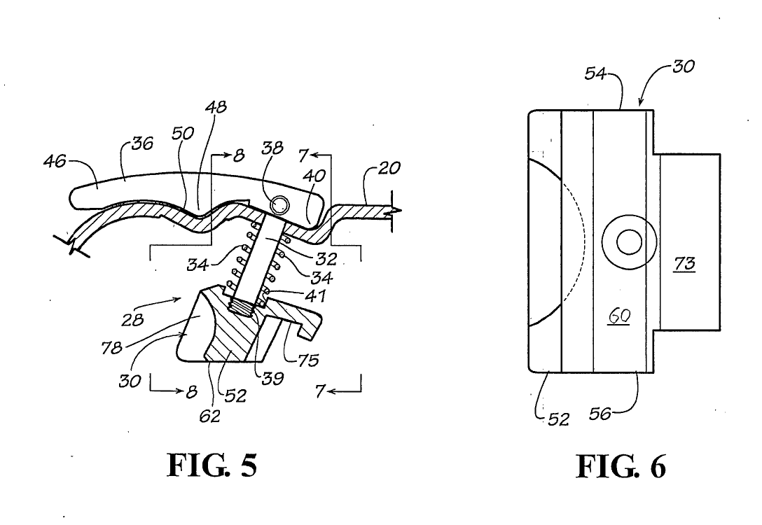

As shown in FIG. 5, a ball clamp assembly 28 includes a ball clamp 30, a clamp pin 32, a coil compression spring 34, a lock lever 36, and a connector pin 38. The ball clamp 30 includes an internally threaded bore 39 and a counter bore 41 that extend downwardly through its upper surface. Clamp pin 32 is threaded at its lower end into the threaded bore so as to be threadedly connected in the threads of the ball clamp 30.

Coil compression spring 34 surrounds the clamp pin and its lower end fits into the counter bore 41. The clamp pin 32 extends up through horizontal top wall 20, and the lock lever 36 is positioned on the top wall 20 of the ball socket and is connected intermediate its ends by means of the connector pin 38 to the upper end of the clamp pin so that it pivots about the connector pin at the top of the clamp pin 32.

The connector pin 38 and the upper end of the clamp pin 32 are displaced laterally from the rear end of the lock lever 36 so that the rear end of the lock lever includes a bearing point 40 that functions as a moving fulcrum when the lock lever 36 is raised, as shown in FIG. 10. The bearing point 40 is tilted downwardly from the connector pin, from the position shown in FIG. 5 to the position shown in FIG. 10, by lifting the lock lever 36 in the direction as indicated by arrow 42 of FIG. 10, causing the clamp pin 32 to withdraw upwardly through the horizontal top wall 20 of the mounting sleeve 18. By lifting the lock lever 36 as shown in FIG. 10, the connector pin 38 pulls the ball clamp 30 upwardly as shown by arrow 77 of FIG. 10, causing the coil compression spring 34 to be compressed between the facing surfaces.

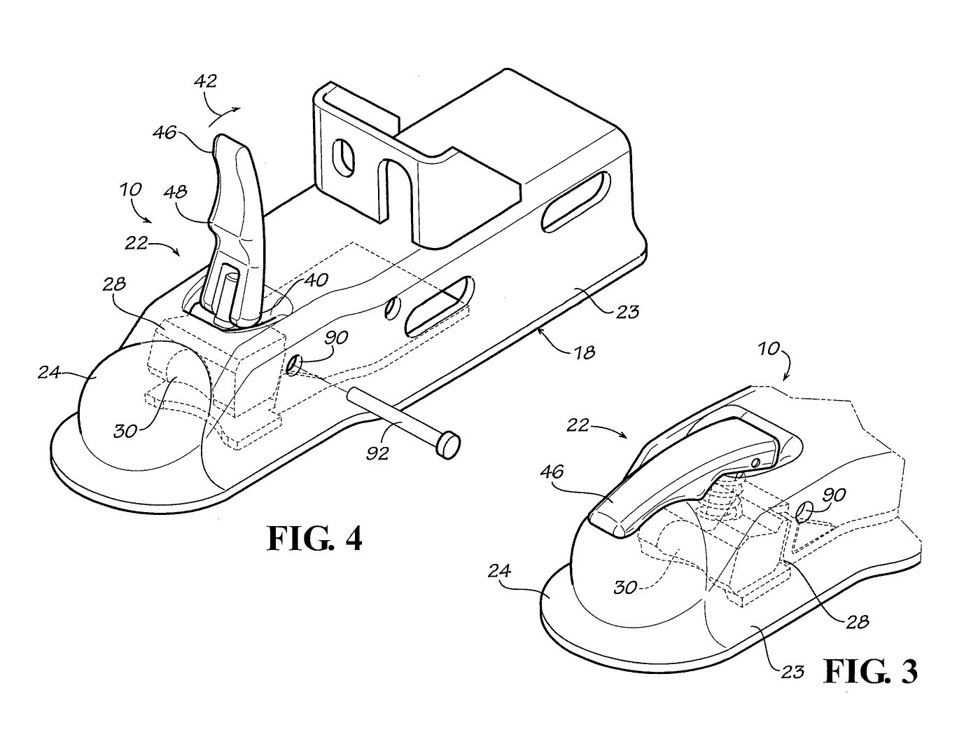

The lifting end or “handle” 46 of the lock lever 36 is directed forwardly of the mounting sleeve 18, and the lower surface of the lock lever has a downwardly facing protrusion 48. A recess 50 is formed in the horizontal top wall 20 of the mounting sleeve 18 that receives and nests with the protrusion 48 of the lock lever. The nesting between the protrusion 48 and recess 50 tends to provide stability to the lock lever 36 so that the lock lever tends to remain in its nested configuration when the lock lever is lowered back to its locked position shown in FIGS. 1, 2, 3, 5, and 9.

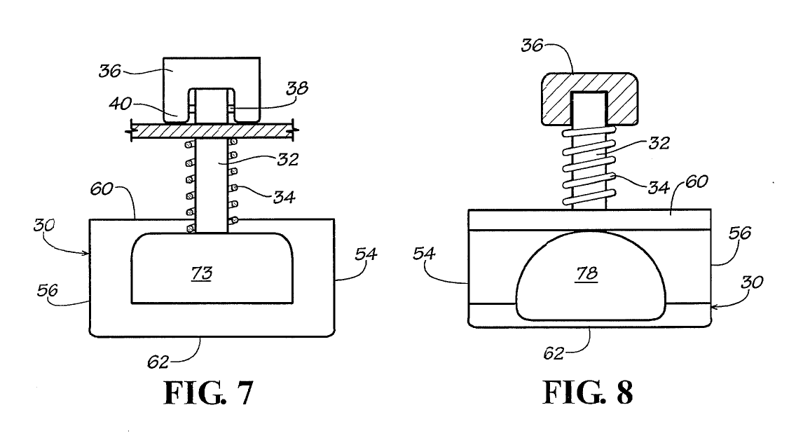

As shown in FIGS. 5-8, ball clamp 30 includes a top wall 60, end walls 54 and 56, and bottom wall 62.

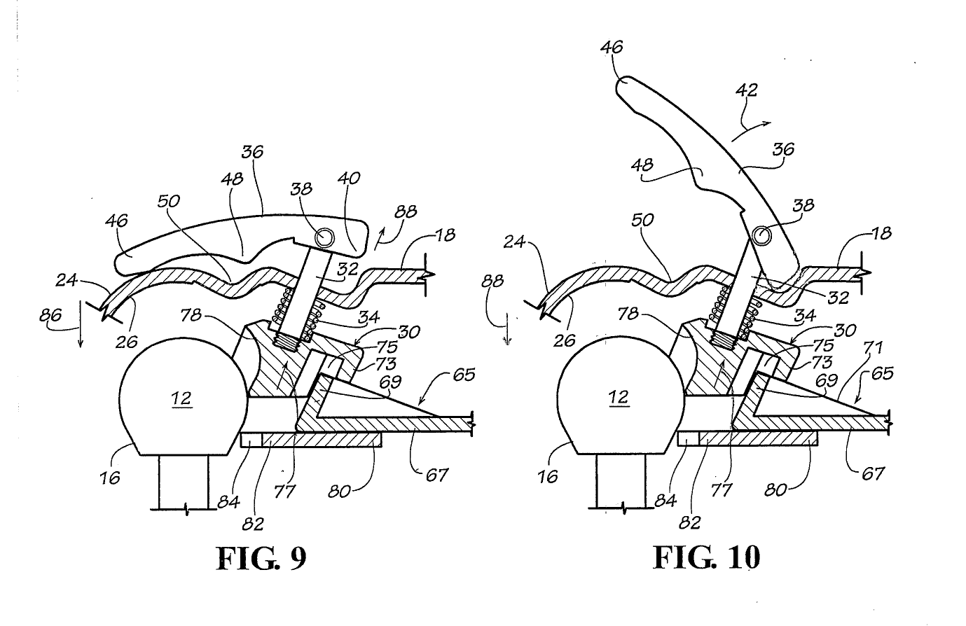

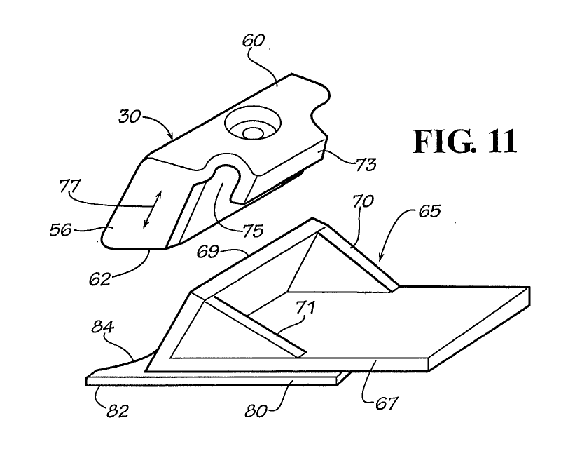

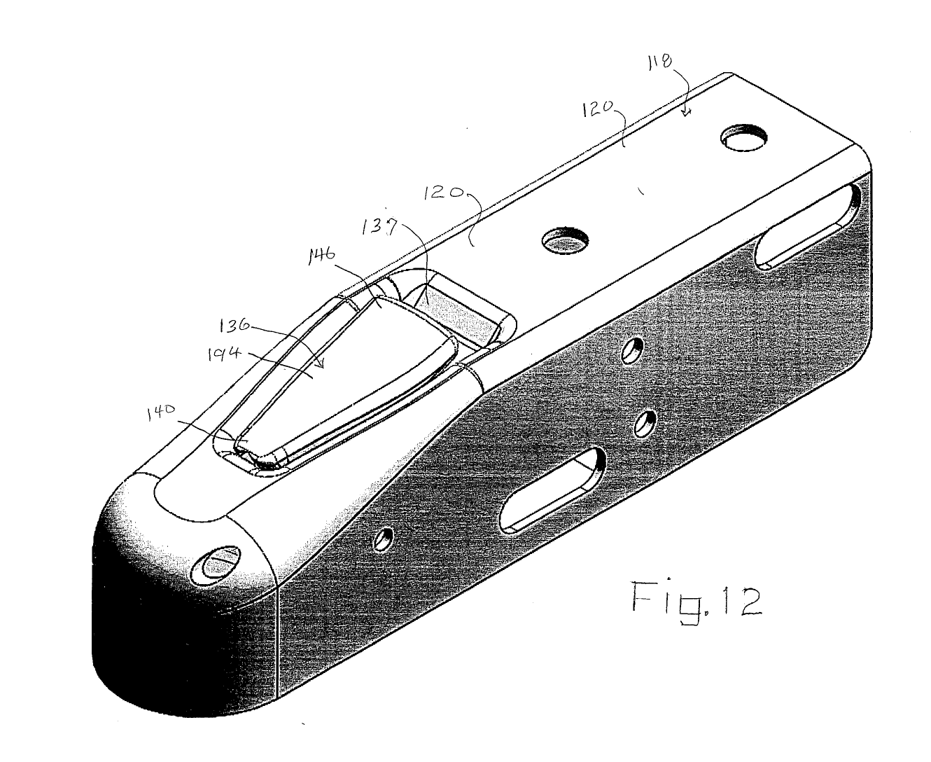

As shown in FIGS. 9, 10 and 11, a ball clamp support 65 is positioned adjacent the ball clamp 30 and is supported by and suspended between the opposed side walls 23 of the mounting sleeve 18 of the trailer hitch 10. The ball clamp support 65 includes a horizontal platform 67 and upturned, sloped tongue 69, and opposed side wings 70 and 71 that extend between the edge of the horizontal platform 67 and the edges of the sloped tongue 69.

Ball clamp 30 includes a laterally extending L-shaped flange 73 that forms a groove 75 that is sized and shaped to receive the sloped guide tongue 69 of the ball clamp support 65. This forms a tongue and groove relationship between the ball clamp support 65 and the ball clamp 30 so that the L-shaped flange 73 requires the ball clamp 30 to move in an upwardly sloped direction as indicated by arrow 77 when the trailer hitch 10 is to be withdrawn from or mounted onto the hitch ball 12, as indicated in FIGS. 9 and 10.

The main body portion 52 of the ball clamp 30 further includes a semi-spherical bearing surface 78 that corresponds in size and shape to the adjacent surface of the hitch ball 12 so that when the ball clamp 30 is moved by its coil compression spring 34 downwardly against the direction of arrow 77 in FIGS. 9 and 10, the semi-spherical bearing surface 78 forms an extension of the inner surface of the ball socket and engages the hitch ball 12 at a position adjacent the converging lower portion 16 of the hitch ball, thereby locking the trailer hitch 10 to the hitch ball 12.

The tongue and groove relationship established between the ball clamp support 65 and the ball clamp 30 assures that the movement of the ball clamp 30 is always sloped toward or away from its locking position with respect to the hitch ball 12. Further, the L-shaped flange 73 limits the downward movement of the ball clamp 30, assuring that the ball clamp will be moveable between the desired up and down positions within the trailer hitch 10.

As shown in FIGS. 2, 9, 10 and 11, a shield plate 80 is supported at its side edges to the opposed side walls 23 of the mounting sleeve 18 and extends horizontally beneath the ball clamp 30 of the trailer hitch and projects out from beneath the horizontal platform 67 of the ball clamp support 65, with the projection 82 defining an arcuate edge 84 formed so as to be compatible with the curvature of the hitch ball 12. The shield plate 80 tends to guide the downwardly facing opening formed by the ball socket 24 to accurately receive the hitch ball, without likelihood that the hitch ball will engage the bottom surface of the ball clamp 30, thereby protecting against aggressive forces being applied to the ball clamp 30. The L-shaped flange 73 and its groove 75 are dimensioned so that a smooth sliding relationship is formed between the ball clamp 30 and the ball clamp support 65, and so that the ball clamp 30 moves downwardly adjacent to, but preferably not in contact with, the shield plate 80, as shown by the dash lines in FIG. 10. This avoids the ball clamp from applying a downward force on the shield plate 80.

As shown in FIG. 9, when the trailer hitch 10 is to be mounted on the hitch ball 12, the trailer hitch is moved downwardly as indicated by arrow 86, so that the ball clamp 30 is engaged against the hitch ball 12, causing the ball clamp to be lifted as indicated by arrow 77. It will be noted that the sloped direction of upward movement of the ball clamp tends to move the ball clamp out of the way of the oncoming hitch ball 12 until the hitch ball has fully entered the ball socket 24, whereupon the coil compression spring urges the ball clamp 30 downwardly to its locked position as shown in FIG. 2. In the meantime, as the ball clamp moves upwardly within the ball socket 24, and the upward movement of the ball clamp tends to lift the lock lever 36 as shown by arrow 88 of FIG. 9. Once the ball socket 24 has been fully mounted to the hitch ball 12, the coil compression spring 34 moves the ball clamp downwardly in the direction opposite to arrow 77 until the L-shaped flange 73 rests upon the sloped guide tongue 69, as previously described.

When it is desired to remove the ball socket assembly 22 from its mounting position on the ball hitch 12, the lock lever 36 is lifted so that it moves in the direction indicated by arrow 77 which, in turn, lifts the ball clamp against the bias of its coil compression spring 34 as shown in FIG. 10, thereby opening the ball socket 24 so that the trailer hitch 10 can be lifted off the hitch ball 12.

The sloped guide tongue 69 tends to stabilize the ball clamp 30 during its up and down movements, and also when the trailer tends to over-run the hitch ball resulting from the braking force applied by the towing vehicle to the trailer.

The ball clamp 30 may be locked in its down position by inserting a lock pin 92 through openings 90, so that the lock pin prevents the upward movement of the ball clamp.

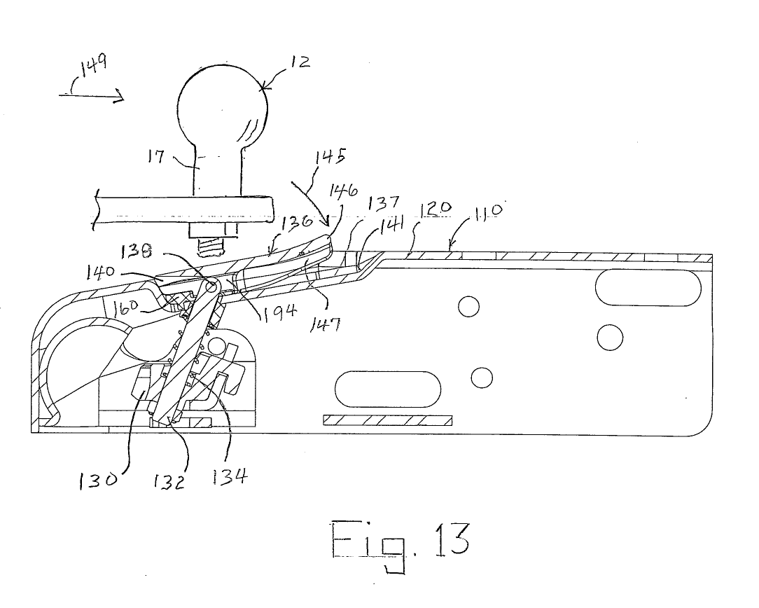

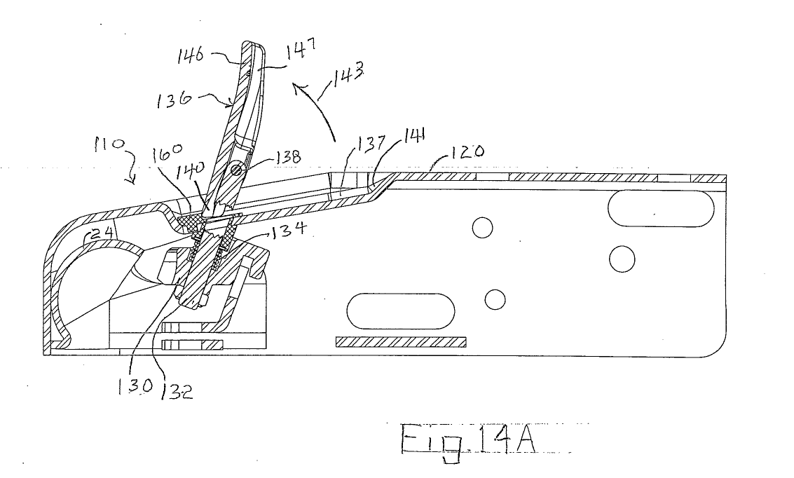

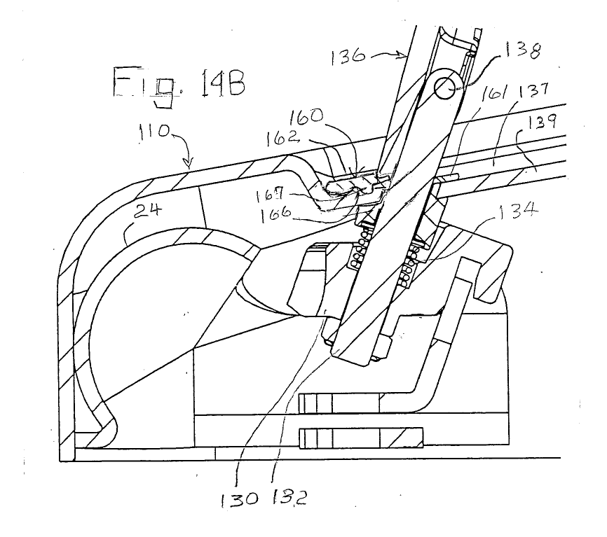

FIGS. 12-17 illustrate another embodiment of the invention, wherein the lock lever 136 is arranged to pivot in the opposite direction from the embodiments of FIGS. 1-11. The lock lever is mounted in a recess 137 that is formed in the horizontal top wall 120 of the mounting sleeve 118. The lock lever is pivotal so its rearwardly directed end portion or “handle” 146 may be lifted upwardly and forwardly as indicated by arrow 143 of FIGS. 14 and 15.

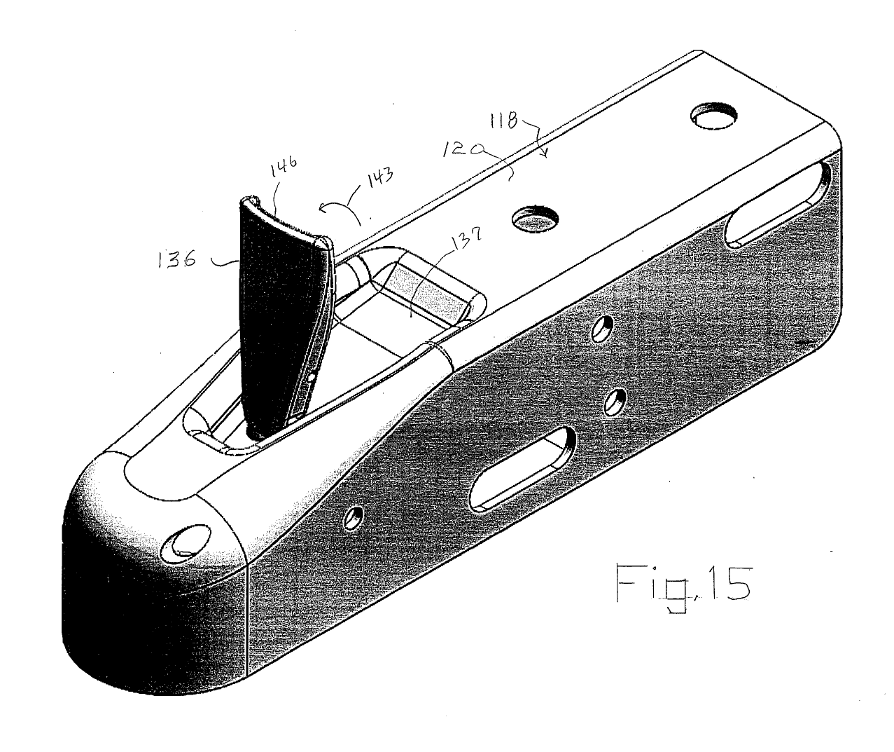

As shown in more detail in FIGS. 13, 16A and 16B the lock lever 136 includes an intermediate portion 194 that is pivotally connected to connector pin 138 of clamp pin 132, a fulcrum bearing point 140 positioned forwardly of the intermediate portion, and lifting end or “handle” 146 positioned rearwardly of the fulcrum bearing point.

The configuration of the ball clamp assembly 128 of FIGS. 13 and 14 may be substantially identical to that shown in FIGS. 1-11, in that it includes the ball clamp 130 that is movable along the length of clamp pin 132 when the trailer hitch 110 is moved downwardly onto a hitch ball, in that the ball clamp 130 is urged out of the way of the hitch ball as it moves down onto the hitch ball and the hitch ball enters the ball socket 114, against the bias of coil compression spring 134. When the ball socket 114 has been mounted on the hitch ball, the coil compression spring urges the ball clamp 130 back into its locked position with respect to the hitch ball as shown in FIG. 13.

As with the previously described embodiment, when the ball clamp 130 is to be lifted away from the hitch ball in order to allow the trailer hitch to be disconnected from the hitch ball of the towing vehicle, the handle or lifting end 146 of lock lever 136 is lifted in the direction indicated by arrow 143 of FIG. 14 until fulcrum bearing point 140 is in substantial vertical alignment with connector pin 138, so that the lock lever 136 may be maintained in its upright position as shown in FIG. 14.

When the ball clamp 130 is to be moved into engagement with the hitch ball, the handle of lever 136 may be moved in the direction indicated by arrow 145 of FIG. 13, back to its nested position with respect to the lock lever recess 137 formed in the upper surface of the mounting sleeve 118.

The lock lever recess 137 has a bottom wall 139, is sized and shaped to be compatible with the size and shape of lock lever 136 so that, as shown in FIGS. 12 and 13, when the lock lever is moved to its horizontal position, the coiled compression spring 134 pulls the lock lever down into the recess 137 and the upper surface of the lock lever 136 becomes substantially coextensive with the upwardly extending adjacent surfaces of the mounting sleeve 118. The upper exposed surface of the lock lever 136 is positioned so that it is coextensive with the adjacent surface of the mounting sleeve or other components of the trailer hitch to reduce the likelihood of destructive contact with any exterior objects that might otherwise engage the lock lever.

For example, FIG. 13 illustrates an oncoming hitch ball, moving as indicated by arrow 149 toward the lock lever of trailer hitch 110. If the components of the hitch ball should make a direct contact with the lock lever 136 as illustrated in FIG. 13, it is likely that the hitch ball will tend to deflect the lock lever into its nested position within the lock lever recess 137 so that the hitch ball does not damage or deform the lock lever.

As illustrated in FIG. 13, the handle 146 of lock lever 136 includes a downwardly facing recess 147 that provides a finger hole for the operator of the trailer hitch, allowing the operator to place his/her finger in the downwardly facing recess 147 and lift the handle 146 of the lock lever 136 in an upward arc as indicated by arrow 143. A gap 141 is located between the handle or lifting end 146 and the rear portion of the recess 137, allowing the operator to reach into the downwardly facing recess 147 that forms the finger hole.

As shown in FIG. 13, when an obstacle, such as the hitch ball of a towing vehicle engages the lock lever when the handle is in its up position shown in FIG. 14, engagement with the hitch ball or other portion of the towing vehicle urges the handle rearwardly so that the coil compression spring pulls the lock lever downwardly through the arc into its recess 137 as shown by arrow 145 in FIG. 13. The spring tends to cause the ball clamp 130 to move from its lifted position of FIG. 14 to its locking position as shown in FIG. 13, which is a safety feature of the invention.

As shown in FIG. 13, when lock lever is nested in the recess, there is substantially no upwardly extending protrusion formed by the lock lever 136 above the surface of the socket housing that would become damaged by external objects. In the meantime, the obstruction moving it as shown by arrow 149 in FIG. 13, if wide enough, would tend to ride along the edges of the recess 137 to reduce the likelihood of destructive damage to the lock lever. In this situation, the perimeter edges of the lock lever recess 137 become a bearing surface that tends to protect the deterioration or destruction or damage applied to the lock lever 136 when encountering other objects.

FIGS. 13, 14A, 14B and 17A-17D illustrate a latch catch 160 that is positioned in the recess 137 of the socket housing. The latch catch is in the form of a plate that has thin end portion 161, a thick end portion 162 and an intermediate ridge 164 dividing the thin and thick portions. A circular opening 165 is formed in the thin portion.

As shown in FIGS. 13 and 14A and 14B, the latch catch 160 is positioned in the recess 137 of the socket housing, between the lock lever 136 and the bottom wall 139 of the recess, with the clamp pin 132 extending through the circular opening 165 and tends to rest on the bottom wall 139 of the recess 137, with the intermediate ridge 164 facing rearwardly of the ball socket assembly. The clamp pin 132 maintains the latch catch 160 aligned in the recess 137. When the lock lever 136 is in its horizontal attitude as shown in FIG. 13, the fulcrum end 140 of the lock lever rests on the thick end portion 162 of the latch catch. When the handle or lifting end 146 of the lock lever is lifted as shown by the arrow 143 of FIG. 14, the fulcrum end 140 of the lock lever moves off the thick end portion 164 of the latch catch, over the intermediate ridge 164 and the spring 134 urges the fulcrum end 140 toward engagement with the thin end portion of the latch catch adjacent the intermediate ridge 164. As shown in FIG. 14, the lock lever becomes caught in its upright position by the intermediate ridge 164, with the ball clamp 130 lifted out of engagement with the hitch ball, allowing the trailer hitch to be lifted away from the hitch ball.

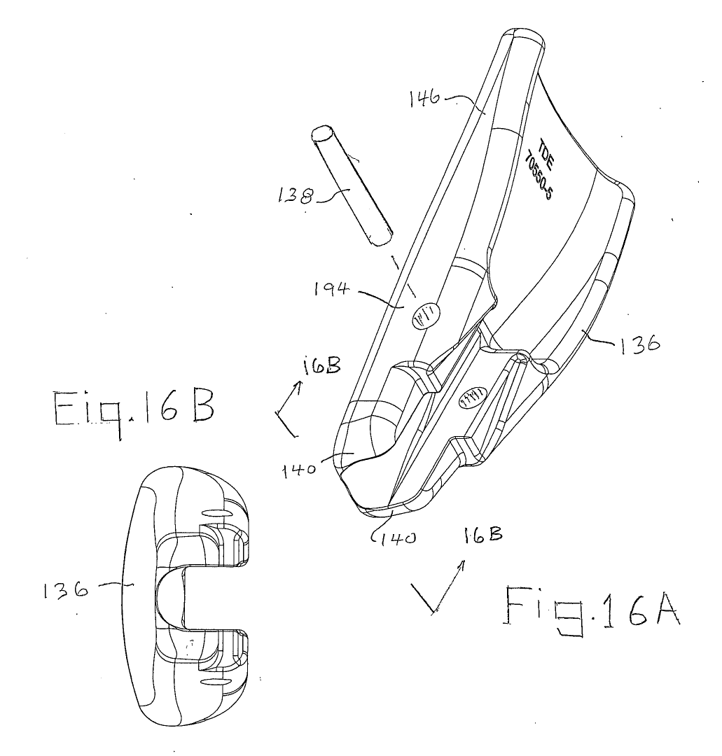

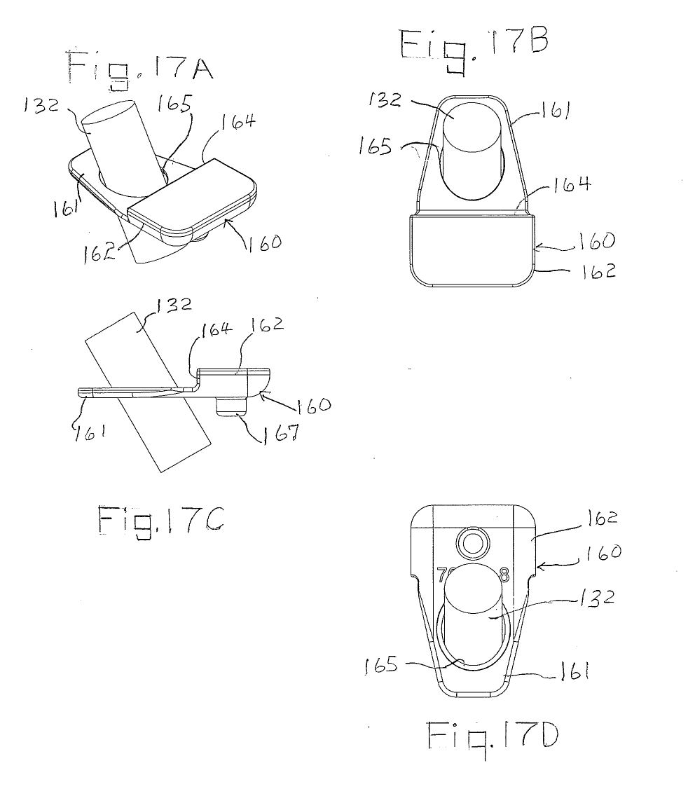

As shown in FIGS. 14B and 17C, the latch catch 160 includes a protrusion 167 that extends downwardly from the bottom surface of the thick end portion 162. The bottom wall 139 defines an alignment hole 166 and the protrusion 167 registers with the alignment hole 166. This arrangement keeps the latch catch properly aligned with the recess 137.

When the ball socket assembly is re-connected to a hitch ball, the downward movement of the ball socket assembly against the hitch ball causes the ball clamp 130 to be pushed upwardly within the ball socket assembly, causing the clamp pin 132 to lift the lock lever 136. The lifting of the lock lever allows the fulcrum 140 to clear the intermediate ridge 164 of the latch catch 160 and the lock lever tends to pivot under the influence of gravity on the lifting end of the lock lever back toward its horizontal position shown in FIG. 13. When the ball clamp moves back to its lower position about the hitch ball, the spring maintains the lock lever 136 in its horizontal position nested within the recess 137.

Although preferred embodiments of the invention have been disclosed in detail herein, it will be obvious to those skilled in the art that variations and modifications of the disclosed embodiments can be made without departing from the spirit and scope of the invention as set forth in the following claims.

1. A trailer hitch for mounting the draw bar of a trailer to a hitch ball of a towing vehicle, the hitch ball of the towing vehicle including a semi-spherical upper portion and a lower portion that converges beneath the larger lateral breadth of the semi-spherical upper portion to a stem of smaller breadth,
said trailer hitch comprising:
a ball socket assembly for mounting on the hitch ball, said ball socket assembly defining a ball socket including a concave interior upper surface that corresponds in size and shape to the semi-spherical upper portion of the hitch ball for mounting about the semi-spherical upper portion of said hitch ball, and
a ball clamp movably supported by said ball socket assembly, said ball clamp including a concave ball engaging surface that corresponds in size to the lower portion of the hitch ball for engaging the hitch ball of the towing vehicle at the stem of the hitch ball below the larger lateral breadth of the hitch ball for movably locking the trailer hitch to the hitch ball of the towing vehicle,
a lever mounted on said ball socket assembly and including an intermediate portion connected to said ball clamp, a handle extending from said intermediate portion rearwardly away from said ball socket, and a fulcrum extending from said intermediate portion opposite to said handle,
said ball socket assembly including a recess for receiving said handle with said lever positioned in said recess flush with the surface of said ball socket assembly for reducing the likelihood of damaging engagement with other objects.

2. The trailer hitch of claim 1, and further including
a ball clamp support mounted to said ball socket assembly configured to guide the ball clamp toward and away from its locking position and for supporting said ball clamp when said ball socket is mounted on the hitch ball with the ball clamp in its locking position, and
wherein said ball clamp and said ball clamp support include a tongue and groove connection that guides the ball clamp along said clamp support.

3. The trailer hitch of claim 2, wherein said ball clamp support includes a clamp tongue that extends parallel to the path of movement of said ball clamp, and said ball clamp includes a tongue groove that is sized and shaped to receive said clamp tongue and guide said ball clamp toward and away from its locking position.

4. The trailer hitch of claim 3, and further including a biasing means supported by said ball socket assembly for urging said ball clamp along said clamp tongue toward the hitch ball at the stem of the hitch ball.

5. The trailer hitch of claim 4, wherein said biasing means comprises a coil compression spring engaging said ball clamp.

6. The trailer hitch of claim 2, and further including a clamp pin connected to said ball clamp, a coil compression spring surrounding said clamp pin, said lever connected to said clamp pin for moving said ball clamp along said clamp tongue from below the hitch ball.

7. The trailer hitch of claim 1, wherein said ball socket defines a lock pin opening aligned through the path of movement of said ball clamp, and a lock pin sized and shaped to extend through said lock pin opening for locking said ball clamp in position below the larger lateral breadth of the hitch ball.

8. The trailer hitch of claim 1 and wherein said ball socket assembly includes
a shield mounted to said ball socket beneath said ball clamp and shaped to cover the bottom surface of said ball clamp and defining a circular recess for admitting a hitch ball to move into engagement with said ball clamp.

9. A trailer hitch for mounting the draw bar of a trailer to a hitch ball of a towing vehicle, the hitch ball of the towing vehicle including a semi-spherical upper portion and a lower portion that converges beneath the larger lateral breadth of the semi-spherical upper portion to a stem of smaller breadth,
said trailer hitch comprising
a ball socket assembly including a socket housing defining a ball socket sized and shaped to receive the semi-spherical upper portion of a hitch ball, a ball clamp in said socket housing sized and shaped to engage the lower portion of the hitch ball, a clamp pin connected to said ball clamp and extending through said socket housing for lifting said ball clamp out of engagement with the lower portion of the hitch ball
a lock lever mounted on said socket housing connected to said clamp pin for lifting said ball clamp out of engagement with said hitch ball,
a recess formed in said socket housing configured to receive said lock lever nested therein,
said lock lever including an intermediate portion pivotally connected to said clamp pin, and a handle end extending rearwardly from said intermediate portion, and a fulcrum end extending forwardly from said intermediate portion for bearing against said recess and lifting said ball clamp away from the hitch ball, and
a spring for urging said lock lever toward a nested position in said recess.

10. The trailer hitch of claim 9, wherein
said ball clamp defines a groove,
a ball clamp support that includes a guide tongue sized and shaped to slidably receive said groove of said ball clamp and to guide said ball clamp toward and away from clamping relationship with respect to the hitch ball.

11. The trailer hitch of claim 9, and further including
a latch catch positioned in said recess including a ridge for engagement by said fulcrum end of said lock lever to retain said ball clamp out of engagement with the hitch ball.

12. The trailer hitch of claim 11, wherein said latch catch defines an opening therein for engaging about said latch pin.

13. A trailer hitch for mounting the draw bar of a trailer to a hitch ball of a towing vehicle, the hitch ball of the towing vehicle including a dome-shaped upper portion and converging in its lower portion toward a stem of smaller breadth,
said trailer hitch comprising a socket housing defining a ball socket for mounting on the hitch ball, said ball socket defining an interior upper surface that corresponds in size and shape to the dome shaped upper portion of the hitch ball for surrounding and resting on the dome shaped upper portion of said hitch ball,
a ball clamp positioned adjacent said ball socket for extending toward the lower portion of said hitch ball and holding said ball socket on the hitch ball and movable away from said hitch ball for forming an opening at said ball socket large enough for the passage of said hitch ball into said ball socket,
biasing means carried by said socket housing for urging said ball clamp toward said lower portion of said ball socket,
a lock pin having one end connected to said ball clamp and another end extending through said socket housing,
a lock lever positioned on said socket housing and pivotally connected to said clamp pin for moving said ball clamp away from said ball socket, and
said socket housing defining a recess for receiving said lock lever with said lock lever at a depth to avoid destructive impact of an object sliding over said socket housing.

14. The trailer hitch of claim 13, wherein said ball clamp extends about the lower portion of the hitch ball and forms a portion of said ball socket.

15. The trailer hitch of claim 14, wherein said biasing means comprises a coil spring, and said lock lever is moveably mounted to said socket housing and is connected to said ball clamp and is configured to move said ball clamp against the bias of said spring for withdrawing said ball clamp from said ball socket.

16. A trailer hitch comprising a ball socket housing defining a ball socket for mounting on a hitch ball,
a ball clamp movably supported by said ball socket housing,
a lock lever mounted on said ball socket housing, said lock lever including an intermediate portion connected to said ball clamp, a handle extending from said intermediate portion rearwardly away from said ball socket, and a fulcrum extending forwardly toward said ball socket,
said ball socket housing defining a recess sized and shaped to receive said lock lever at a level in said recess flush with the surface of said ball socket housing to avoid destructive contact with objects moving across said recess.

17. The trailer hitch of claim 16, and further including
a latch catch defining a latch edge positioned in the path of movement of the fulcrum of the lever for engagement by the fulcrum when said handle of said lock lever is raised.

18. The trailer hitch of claim 16, and further including
a lock pin having one end connected to the intermediate portion of said lock lever and another end connected to said ball clamp,
wherein said latch catch defines an opening for engaging about said lock pin for maintaining said latch catch in position to become engaged by said fulcrum of said lock lever.

19. A trailer hitch for mounting the draw bar of a trailer to a hitch ball of a towing vehicle,
said trailer hitch comprising a socket housing defining a ball socket for mounting on the hitch ball,
a ball clamp for extending toward the lower portion of said hitch ball and movable away from said hitch ball for forming an opening in said ball socket large enough for the passage of said hitch ball into said ball socket,
biasing means carried by said socket housing for urging said ball clamp toward said lower portion of said ball socket,
a lock pin having one end connected to said ball clamp and another end extending through said socket housing,
a lock lever positioned on said socket housing and pivotally connected to said clamp pin,
a latch catch positioned on said socket housing in the path of movement of said lock lever configured for maintaining said lock lever in its raised position.

20. A trailer hitch comprising a ball socket housing defining a ball socket for mounting on a hitch ball,
a ball clamp movably supported by said ball socket housing,
a lock pin connected at one end to said ball clamp
a lock lever mounted on said ball socket housing, said lock lever including an intermediate portion connected to said lock pin, a handle extending from said intermediate portion in one direction away from said ball socket, and a fulcrum extending opposite to said handle, so that when the handle of said lock lever is lifted the fulcrum engages said ball socket housing and said intermediate portion lifts said lock pin and said ball clamp socket, and
a latch catch supported by said socket housing positioned adjacent said lock lever for engaging said fulcrum and maintaining said ball clamp out of engagement with the hitch ball.

21. The trailer hitch of claim 20, and further including a spring surrounding said lock pin for urging said ball clamp toward engagement with the hitch ball.

22. The trailer hitch of claim 21, wherein said spring is positioned to maintain said fulcrum in releasable engagement with said latch catch.

23. A trailer hitch comprising a ball socket housing defining a ball socket for mounting on a hitch ball,
a ball clamp movably supported by said ball socket housing,
a lock lever mounted on said ball socket housing, said lock lever including an intermediate portion connected to said ball clamp, a handle extending from said intermediate portion in one direction away from said ball socket, and a fulcrum extending from said intermediate portion in another direction away from said ball socket, and
a latch catch positioned on said socket housing configured to engage the fulcrum of said lock lever.
